(19) United States
(12) Patent Application Publication
(10) Pub. No.: US 2005/0288997 A1
(43) Pub. Date: Dec. 29, 2005

(54) User guidance system in a pay point network

(76) Inventor: Thierry Machicoane, Champagney (FR)

Correspondence Address: SOFER & HAROUN LLP., 317 MADISON AVENUE, SUITE 910, NEW YORK, NY, 10017, US

(21) Appl. No.: 10/522,487

(22) PCT Filed: Jun. 26, 2003
(86) PCT No.: PCT/FR03/01974

§ 371 Date: Apr. 14, 2005

(30) Foreign Application Priority Data
Jul. 31, 2002 (FR) 02/09791

(51) Int. Cl. G06F 17/60

(52) U.S. Cl. 705/13; 705/1

(57) ABSTRACT

A system is provided for guiding a user in a network of pay points delivering goods or services, such as parking ticket dispensers for paying parking fees. The system includes a first means for supplying to the user information on the location of the machine (X).

The present invention relates to a user guidance system in a pay point network and in particular a network of parking pay points. The present invention relates more particularly to a guidance system intended to enable a user to find a pay point easily.

Thanks to a system of the above kind, a motorist who has parked his vehicle in a parking space for which a parking fee is payable is able to find his vehicle if he forgets where it is parked or wishes to return to his vehicle by the shortest route.

The present invention also relates to the means employed by said system of the invention. In this regard, the present invention relates more particularly to the pay points used and in particular to on-street vehicle parking pay points.

For many years, parking motor vehicles in towns has been subject to the payment of a parking fee. To leave his vehicle in a parking space, a motorist must prepay an amount corresponding to the chosen parking time.

To occupy a parking space for which a parking fee is payable, the user must therefore pay a parking fee at an appropriate pay point. Pay points of this kind are better known as parking meters or parking ticket dispensers.

The parking meter system consists in a machine in which motorists wishing to park must pay an amount corresponding to the required parking time by means of coins, cards, etc. A display mechanism on the machine then displays a pointer corresponding to the parking time that has been paid for. This pointer then moves backwards as time passes. It is simple to monitor a system of this kind since it is sufficient for parking wardens to note the position of the pointer to tell if the vehicle occupying the space controlled by the machine in question is legally parked or not.

In the case of parking ticket dispensers, in return for payment for the required parking time by means of coins, appropriate payment cards, mobile telephones, etc., the user receives a ticket carrying printed information and in particular the time until which parking is authorized. The user must place this ticket visibly behind the windshield of his vehicle. Parking wardens then check that parked cars are displaying a ticket and note the parking expiry time indicated on the ticket.

Whichever type of pay point is used (parking meter or parking ticket dispenser), the user's vehicle is always in the immediate vicinity of, meaning less than a hundred meters away from, the machine used to pay the parking fee.

Finally, sooner or later, the user must return to his vehicle or pay a new amount before the parking time already paid for expires if his vehicle is not to be illegally parked and attract a fine.

The user therefore has to remember where he parked his vehicle. Because of the increasing size of modern towns, it happens increasingly often that a user is unable to remember very clearly where he left his vehicle.

This phenomenon is even more accentuated when the user is in a town other than his home town, or even abroad, and is therefore unfamiliar with the local topography.

The present invention therefore proposes to assist a user who has used a pay point to pay a parking fee to find his vehicle. The invention assists the user to find where his vehicle is parked.

According to the invention, the system for guiding a user in a network of pay points delivering goods or services, such as parking ticket dispensers for paying parking fees, is characterized in that some or all of the machines on the network comprise first means for supplying to the user information on the location of said machines.

According to another feature of the guidance system of the invention, said means of the machines of the network for supplying the user with location information cooperate with payment means of said machines so that said location information is not supplied to the user until a payment for goods or services has been effected at said machines.

According to another feature of the guidance system of the invention, the information on the location of the machines of the network consists in a unique identification code for each machine.

According to another feature of the guidance system of the invention, the information on the location of a machine is printed on a ticket issued by printing means of said machine.

According to another feature of the guidance system of the invention, some or all of the machines adapted to supply to the user information on the location of the machines include appropriate writing means for transferring said information on the location of said machines into the appropriate memories of a contact or contacts type microprocessor card of the user, such as a payment card.

According to another feature of the guidance system of the invention, some or all of the machines adapted to supply to the user information on the location of the machines include appropriate radio-frequency transmission means for transferring said information on the location of said machines by radio into the memories of a suitable terminal of the user, such as a mobile telephone, for example in the form of a voice telephone call, or in the form of a text message such as an SMS text message or an e-mail.

According to another feature of the guidance system of the invention, some or all of the machines of the network include second means for supplying guidance information enabling the user to go from said machine to any other machine of said network, said second means including acquisition means for acquiring information on the location of said other machine supplied by the user.

According to another feature of the guidance system of the invention, the means of a first machine of the network for providing guidance information for going from said first machine to a second machine of said network cooperate with payment means of said machine so that said guidance information is supplied to the user only after a payment for a service of this kind has been effected at said first machine.

According to another feature of the guidance system of the invention, the acquisition means include a man-machine interface, such as a keypad, on which said user may enter information on the location of a machine to which he wishes to go.

According to another feature of the guidance system of the invention, the acquisition means include a microprocessor card reader for recovering said information on the location of a machine in the appropriate memories of a contact or contactless type microprocessor card of the user, such as a payment card.

According to another feature of the guidance system of the invention, the acquisition means include appropriate radio-frequency receiving means for downloading by radio said information on the location of a machine from a suitable communication terminal of the user, such as a mobile telephone, for example in the form of an SMS message.

According to another feature of the guidance system of the invention, the guidance information for going to a machine of the network is printed on a ticket issued by printing means of said machine supplying the guidance information.

According to another feature of the guidance system of the invention, the guidance information for going to a machine of the network is displayed on an appropriate screen of said machine supplying the guidance information.

According to another feature of the guidance system of the invention, the guidance information for going to a machine of the network is communicated by voice synthesis means of said machine supplying the guidance information.

According to another feature of the guidance system of the invention, some or all of the machines supplying guidance information include appropriate radio-frequency transmitting means for sending said guidance information for going to a machine of the network to a suitable terminal of the user, such as a mobile telephone, for example in the form of a voice telephone call, or in the form of a text message such as an SMS text message or an e-mail.

According to another feature of the guidance system of the invention, the location and/or guidance information comprises the address of said machine.

According to another feature of the guidance system of the invention, the location and/or guidance information comprises a map of the neighborhood of said machine.

According to another feature of the guidance system of the invention, the guidance information comprises a description of one or more paths to the machine to which the user wishes to return from the machine supplying the information.

According to another feature of the guidance system of the invention, the guidance information comprises a map of one or more paths to the machine to which the user wishes to return from the machine supplying the information.

The objects, aspects and advantages of the present invention will become clear from the following description of embodiments of the invention given by way of non-limiting example and with reference to the appended drawing, in which:

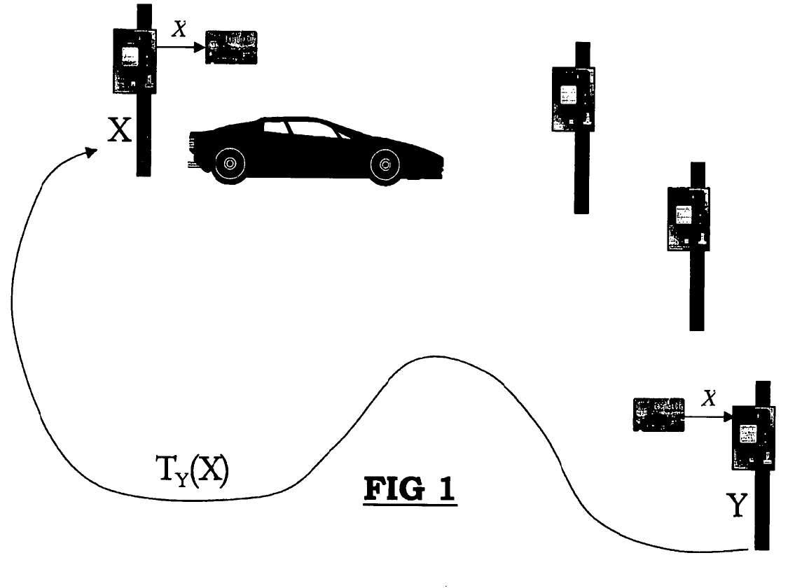

FIG. 1 is a diagram of a pay point network employing the method of the invention.

FIG. 1, in which only elements needed to understand the invention appear, shows two pay points X and Y which in this instance are parking ticket dispensers. These parking ticket dispensers X and Y belong to a network of parking ticket dispensers meshing a built-up area and managed by an operator such as a private organization or a municipal authority. The same network may comprise from several dozen to several thousand parking ticket dispensers according to the size of the town or built-up area concerned. The use of parking ticket dispensers as pay points is obviously not limiting on the present invention.

In streets in which parking has to be paid for, parking ticket dispensers are disposed along the pavement at regular intervals, for example every fifty meters.

The parking ticket dispensers X and Y comprise means for implementing the essential functions of a parking ticket dispenser, that is to say payment means, such as a card reader with electronic memory or microcontroller and/or a coin or token handling device, information entry means, such as a keypad or a thumbwheel, associated with a display screen, in particular for selecting the parking time, printing means, in particular for printing parking tickets to be placed behind the windshield of parked vehicles, a time generator, electrical power supply means, etc. A central unit or microcontroller with appropriate software controls the operation of the parking ticket dispenser and its various peripherals.

All the means cited above are known in the art and will not be described in more detail.

According to the invention, the microcontrollers of the parking ticket dispensers X and Y are equipped with a dedicated program for determining information necessary for locating the parking ticket dispensers and supplying that information to the user. Executing this program corresponds to executing the method of the invention.

A user who has parked his vehicle in a space where a parking fee is payable goes to the nearest parking ticket dispenser X in order to pay the parking fee. When the step of paying the parking fee has been completed, the parking ticket dispenser X offers the user the possibility of locating the parking ticket dispenser.

Selection of this location service by the user pressing a button or a key of the keypad provided for this purpose starts execution of the program cited above.

The location program then determines the information necessary for the location process, for example the number of the building and the name of the street where the parking ticket dispenser X is situated; this information is simply stored in a non-volatile memory of the parking ticket dispenser X.

When the above information has been determined, the parking ticket dispenser X simply prints it on a specific ticket for the user separate from the parking ticket that has to be placed behind the windshield of the user's vehicle.

In a different embodiment, the location information is printed after the usual parking ticket information; in this case the ticket is in two pre-cut parts and the user has only to separate the two parts of the parking ticket, place one in his car and retain on his person the other part, carrying location information.

Of course, depending on the sophistication of the parking ticket dispenser X, the format in which the location information is delivered may be more elaborate. Thus if the parking ticket dispenser X has a graphical printer, the location information may take the form of a detailed map of the neighborhood, with the exact location of the parking ticket dispenser X precisely indicated.

The user recovers and retains the ticket carrying the location information. He may then go about his business freely and contentedly, without having to remember where he has parked. Later, when he wishes to return to his vehicle, it is sufficient for him to consult the location information on the ticket.

A variant of the embodiment of the invention described communicates location information in the form of a code identifying the parking ticket dispenser X. This unique identifier or serial number, running from 1 to the number of pay points constituting the network of pay points, may be printed instead of or in addition to the location information previously referred to.

Once the location ticket has been printed, the user recovers and retains it. He may then go about his business freely and contentedly, without having to remember where he has parked.

Later, when he wishes to return to his vehicle, it is sufficient for the user to go to any parking ticket dispenser Y of the network and select the location function using a button or a key of the keypad provided for this purpose. This function, which may or may not be conditional upon prepayment, then starts execution of the program referred to above.

The program in question then prompts the user to enter the unique identifier of the parking ticket dispenser X printed on the location ticket, by means of a keypad provided for this purpose.

When entry of the unique identifier of the parking ticket dispenser X has been completed, the location program uses the unique identifier to determine the shortest path T_{Y}(X) from the parking ticket dispenser Y to the location of the parking ticket dispenser X and therefore of the vehicle.

This path T_{Y}(X) may be determined by the location program simply reading in a non-volatile memory of the parking ticket dispenser Y a table supplying the path T_{Y}(X) as a function of the unique identifier of the parking ticket dispenser X.

For example, the table may comprise a simple dictionary giving, for a given machine Y, and as a function of the identifier of the destination machine X, the shortest path to that machine X, in a specific format that is not part of the invention. For example, the path could consist of a list of streets to be taken to return to the location of the machine X.

When the path T_{Y}(X) has been determined, the parking ticket dispenser Y simply prints it on a ticket for the user. Of course, depending on the sophistication of the parking ticket dispenser Y, the format in which the path T_{Y}(X) is delivered may be more elaborate. Thus if the parking ticket dispenser Y has a graphical printer, the path T_{Y}(X) may take the form of a detailed map with the respective locations of the parking ticket dispensers X and Y precisely indicated.

If the user wishes to use a smart card to pay his parking fee, another variant of the embodiments of the invention described above consists in using this medium to locate the vehicle, whether the card in question is a memory card, a microcircuit card, of the contact or contactless type, and used to make the payment or not.

Accordingly, in this variant of the method of the present invention, offered by way of illustration, the parking ticket dispenser X stores its unique identifier in the memory or a dedicated file of the user's smart card at a given stage of the process of the user paying his parking fee.

At the end of the payment step, the user recovers his smart card. He may then go about his business freely and contentedly, without having to remember where he has parked. Later, when he wishes to return to his vehicle, it is sufficient for the user to go to the nearest parking ticket dispenser Y and select the location function using a button or a key of the keypad provided for this purpose. That function then starts execution of the program previously cited.

The program in question then prompts the user to insert his smart card into the card reader provided for this purpose. Once the smart card has been inserted correctly into the reader, the latter reads the unique identifier of the parking ticket dispenser X in the memory of the smart card or in the dedicated file.

The unique identifier of the parking ticket dispenser X is then passed to the location program, which uses this information to determine the shortest path T_{Y}(X) from the parking ticket dispenser Y to the location of the parking ticket dispenser X and therefore of the vehicle.

The path T_{Y}(X) may be determined by the location program simply reading in a non-volatile memory of the parking ticket dispenser Y a table providing the path T_{Y}(X) as a function of the unique identifier of the parking ticket dispenser X.

When the path T_{Y}(X) has been determined, the parking ticket dispenser Y simply prints it on a ticket for the user. Of course, depending on the sophistication of the parking ticket dispenser Y, the format in which the path T_{Y}(X) is delivered may be more elaborate. Thus if the parking ticket dispenser Y has a graphical printer, the path T_{Y}(X) may take the form of a detailed map with the respective locations of the parking ticket dispensers X and Y precisely indicated.

Of course, the embodiments described in detail above are provided by way only of illustration of various embodiments of the invention, which is not limited to those embodiments only.

Thus the present invention relates to any pay point network and not only to networks of parking pay points. Accordingly, the present invention may be applied to public telephones, transport ticket dispensers, automatic drinks dispensers, etc.

Accordingly, the communication of location and/or guidance information, whether from the machine to the user or from the user to the machine, may employ radio frequency transmission (GSM, WI-FI, etc.). In this embodiment the machines are equipped with radio-frequency transceiver means for transferring location and guidance information by radio between the machines and a suitable terminal of the user, such as a mobile telephone, for example in the form of a voice telephone call, or in the form of a text message such as an SMS text message or an e-mail.

1. System for guiding a user in a network of pay points delivering goods or services, such as parking ticket dispensers for paying parking fees, said system comprising: a first means for supplying to the user information on the location of said machine.

2. Guidance system according to claim 1, wherein said means for supplying the user with information on the location of said machine cooperate with payment means of said machine so that said location information is not supplied to the user until a payment for goods or services has been effected at said machine.

3. Guidance system according to claim 1, wherein said information on the location of said machine is a unique identification code.

4. Guidance system according to claim 1, wherein said information on the location of said machine is printed on a ticket issued by printing means of said machine.

5. Guidance system according to claim 1, wherein said machine includes appropriate writing means for transferring said information on the location of said machine into the appropriate memories of a contact or contactless type microprocessor card of the user, such as a payment card.

6. Guidance system according to claim 1, wherein said machine further comprises appropriate radio-frequency transmission means for transferring said information on the location of said machine by radio into the memories of a suitable terminal of the user, such as a mobile telephone, for example in the form of a voice telephone call, an SMS text message or an e-mail.

7. Guidance system according to claim 1, wherein said machine includes second means for supplying guidance information enabling the user to go from said machine to any other machine of said network, said second means including acquisition means for acquiring information on the location of said other machine supplied by the user.

8. Guidance system according to claim 7, wherein said means for providing guidance information for going from said machine to any other machine of said network cooperate with payment means of said machine so that said guidance information is supplied to the user only after a payment for a service of this kind has been effected at said machine.

9. Guidance system according to claim 7, wherein said acquisition means of said machine includes a man-machine interface, such as a keypad, on which said user may enter information on the location of said other machine to which he wishes to go.

10. Guidance system according to of claim 7, wherein said acquisition means of said machine includes a microprocessor card reader for recovering said information on the location of said other machine in the appropriate memories of a contact or contactless type microprocessor card of the user, such as a payment card.

11. Guidance system according to any one of claim 7, wherein said acquisition means of said machine includes appropriate radio-frequency receiving means for downloading by radio said information on the location of said other machine from a suitable communication terminal of the user, such as a mobile telephone, for example in the form of an SMS message.

12. Guidance system according to claim 7, wherein said guidance information for going to said other machine is printed on a ticket issued by printing means of said machine.

13. Guidance system according to claim 7, wherein said guidance information for going to said other machine is displayed on an appropriate screen of said machine.

14. Guidance system according to claim 7, wherein said guidance information for going to said other machine is communicated by voice synthesis means of said machine.

15. Guidance system according to claim 7, wherein said machine includes appropriate radio-frequency transmitting means for sending said guidance information for going to said other machine to a suitable terminal of the user, such as a mobile telephone, for example in the form of a voice telephone call, an SMS text message or an e-mail.

16. Guidance system according to claim 1, wherein said location information and/or said guidance information comprises the address of said machine.

17. Guidance system according to claim 1, wherein said location and/or guidance information comprises a map of the neighborhood of said machine.

18. Guidance system according to claim 7, wherein said guidance information further comprises a description of one or more paths to said other machine from said machine.

19. Guidance system according to claim 7, wherein said guidance information further comprises a map of one or more paths to said other machine from said machine.
